(19) United States
(12) Patent Application Publication
(10) Pub. No.: US 2011/0065081 A1
(43) Pub. Date: Mar. 17, 2011

(54) Electrically erasable writable educational flash card

(76) Inventor: Shengmin Wen, Apex, NC (US)

(21) Appl. No.: 12/561,995

(22) Filed: Sep. 17, 2009

(51) Int. Cl. G09B 7/00

(52) U.S. Cl. 434/322

(57) ABSTRACT

The invention provides an electrically erasable writable educational flash card comprising electronic display that displays prescribed patterns such as text characters of a language, Arabic numbers, and graphics pictures of a learning subject. Two or more of such cards comprise a youth oriented subject learning educational flash card set. Such card has a look of conventional paper flash card but with advantages: user can erase and write the displaying contents—making the learning activities more enjoyable and effective; the card is ergonomically fitful for young children to play with; and the card does not consume conventional paper, which is made from plant, trees in particular, and therefore conserves forest and environment. The invention further provides an electronic card writer for user to electrically erase and write the contents on the card's display. Alternatively, a commercially available computer or an electronic paper printer can be adapted as an electronic card writer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention generally relates to the field of educational flash card, and more particularly to an electrically erasable and writable flash card intended for use in teaching young children elements of a learning subject, and even more particularly text characters of a language, Arabic numbers, and graphics pictures of a learning subject, and the like.

2. Description of the Prior Art

Conventional flash cards have been used as teaching tools for centuries not only for their effectiveness but also for its commercial success. They are still produced and sold in various forms at a very reasonable and affordable price to virtually every household and pre-school, for example, the Alphabet Flash Cards produced by the School Zone Publish Company, product #04001 with ISBN 9780938256861 and the Numbers 1-100 Flash Cards, product #04005 with ISBN 9780938256908. Both products are cited as references here and referred to as “conventional paper flash card.” The conventional paper flash cards are permanently printed with unique indicia on each individual card and a complete set of flash cards comprises a plurality of such permanently printed unique individual cards. There are several disadvantages when they are used for teaching young children. Among these disadvantages the most obvious ones are: (1) To teach every alphabet, a whole set of cards is needed all the time. If one card is missing, for example it got lost or damaged, which happens quite often with young children playing with the cards, user needs to buy another whole set to get just the only one card that is missing; (2) The conventional flash cards is made of conventional paper and its mass or weight is seldom ergonomically optimized for young children. Conventional paper letter cards appear less like a toy in comparison to wooden letter blocks, which is more ergonomically favored for young children. For example, the Magnetic Wooden Alphabet toy produced by Melissa & Doug LLC, item number 448, has the ergonomic size and weight for young children. This product is cited here as a reference; (3) Children do not have the fun to make the letter since it is permanently printed and provided. It therefore lacks the most fun of participation for young children at an early age; (4) Conventional flash cards are difficult to play during traveling under special environment settings, such as in an airplane seat where limited space is available to spread out the whole set of cards or in outdoors where wind could easily blow away the cards; (5) To spell a word or a sentence with repeated letters, a number of such sets are needed. For example, to spell the word “vegetable,” three sets of conventional English alphabet flash cards are needed to just get the additional two e's. To spell out a sentence “mommy loves jimmy,” five lower case letters m are needed and therefore user needs to use five sets of flash cards. Five sets would total 130 cards for English alphabets. Such solution is not desirable because not only five sets cost five times more but also precious play time is wasted to find out just the right letters through a pile of 130 cards; (6) One set of alphabet flash cards is not sufficient to play some fun word learning games, such as the fun scrambling and unscrambling word game, because often a word has the same letter more than once. This could be one of the reasons why the conventional alphabet flash cards are not part of children's language learning process any more after their preschool age when they grow out of only learning alphabet.

U.S. Pat. No. 5,199,714 patented Apr. 6, 1996 to D. D. Harper entitled “Method of playing a word solitaire card game” disclosed a card set comprising 52 cards including 50 letter cards and 2 blank cards as wild cards. Even though the patented cards were meant to be game playing cards, it could be used as a set of flash cards. The 50 letter cards are distributed among 26 alphabet letters according to certain frequency with frequently used letters in English word having more cards than less frequently used letters. For example letter “E” has four cards while letter “O” has 3 and letter “Z” has 1. The blank cards can be used as any letter. This deck of cards can form most of words without difficulty, such as the word “vegetable.” It still cannot form a simple sentence like “mommy loves jimmy” because even with the two blank cards are used as m there is still a shortage of one m. This patent overcomes partially the disadvantages (5) and (6) that are listed in previous paragraph.

U.S. Pat. No. 6,276,940 patented Aug. 21, 2001 to C. L. White entitled “Card game for learning the alphabet” disclosed a card set comprising 118 cards. These cards are distributed among 26 alphabet letters according frequencies the alphabet appears in English words. When used as flash cards, the card set does overcome partially both disadvantages (5) and (6) listed above except that to find one particular card through a pile of 118 cards can cause frustration and take time which otherwise could be spent on card playing activities.

U.S. Pat. No. 4,690,410 patented Sep. 1, 1987 to A. S. Berton entitled “Word forming tile game” disclosed a word forming game that uses a set of tiles each formed on one face with a letter and the frequency of occurrence of the letters in the set corresponds to that occurring in English. The patent does not specify the total number of tiles or the size and weight of the tile. Assume size and weight of the tile is taken such that it is ergonomically fit for young children, a total of 50 tiles are likely needed with 26 tiles for each letter and the rest distributed according to frequency tables of the occurrence of letters in words of the English language. When used as flash cards, the tiles could give young child a feeling of size and weight and can be played outdoors thus overcome the disadvantages (2) and partially (4). But to have the necessary number of tiles to overcome (5) and (6), at least 50 tiles are needed just like 50 plus 2 cards are needed as disclosed in the U.S. Pat. No. 5,199,714. These many tiles with a size of standard flash card would not be practical. In reality, these tiles can probably be made to the size as that of tiles used in “Scrabble” (Registered Trade Mark).

Tiles of the word game “Scrabble” (Registered Trade Mark) may also be used as flash cards since each tiles bears one letter. However, the size of a typical Scrabble tile is about 27 mm in diagonal. Such size would be too small for young children to hold or to render adequate visual impression on to them. To use Scrabble tiles as flash cards for young children, it is ideal to enlarge the Scrabble tiles to at least the size of a credit card with 100 mm in diagonal or a standard playing card with 105 mm in diagonal. It is hard to image to carry a bag of 100 pieces of large Scrabble tiles each with a size of 100 mm or more in diagonal. If such large tiles were made, it would still not be possible to spell out “mommy loves jimmy” because Scrabble only has two m's and two blank wild tiles—there still needs one more m tile.

U.S. Pat. No. 1,354,910 patented Oct. 5, 1920 to E. H. Ketchum entitled “Educational Blocks” disclosed a block set that has both alphabet letters and Arabic numeral blocks placed in indexed compartments of a casing or box. Blocks can be easily retrieved because each block has its indexed compartment. The blocks can be damaged and get lost therefore the whole set would be incomplete. Meanwhile, it is not appealing to customers to make the blocks as large as 100 mm in diagonal because then the casing would measure 750 mm wide—inconvenient to store and carry around the blocks.

With new technologies of electronically displaying text and images become mature and commercially available, it is feasible to make an electrically erasable and writable educational flash card. In particular, the reflective bistable display technologies have the advantage of keeping text and images display unchanged when power is switched off. In contrast to conventional CRT or classic LCD display device which needs power on and displays better under darker environment, reflective bistable display device maintains the contents in display when power is switched off and it displays better under brighter environment such as under sunshine, just like the conventional paper. Bistable display does not consume power except when the display content is to be changed. Two examples of such display that are currently commercially available are the bistable nematic liquid crystal display (LCD) by Nemoptic S. A. in France and electronic ink film based electronic paper display technology made by E-ink Corporation in U.S.A. Two representative references are cited here for the bistable nematic liquid crystal display. The first is the datasheet of a Nemoptic catalog product BM 600 BiNem® Module—4.0 inches B&W reflective bistable display module. The second one is the U.S. Pat. No. 7,532,275 B2 issued on May 12, 2009 entitled “Display device with a white-optimizing bistable nematic screen and method for the definition of said device” that specifically disclosed an optimized displays of reflective type. Similarly, two representative references are cited here for the electronic ink film based electronic paper display technology. The first is the datasheet of an E Ink's Active Matrix EPD Prototype Kit. The kit demonstrates how electronic ink film based electronic paper display works and provides necessary tools to develop application prototypes—a clear demonstration that the present invention can be constructed by any person skilled in the art. The second is the U.S. Pat. No. 5,961,804 issued on Oct. 5, 1999 entitled “Microencapsulated electrophoretic display” to Joseph Jacobson (Cambridge, Mass.) et. al. with assignee as Massachusetts Institute of Technology (Cambridge, Mass.). The patent disclosed electronic ink that may be printed onto arbitrary surfaces to form an electronically addressable display. Based on this principle, E Ink Corporation, US, successfully commercialized the technology into electronic paper display.

U.S. Pat. No. 20080234024A1 patented Sep. 25, 2008 to Andrew P. Connors (Reston, Va., US) et. al. entitled “Electronic Playing Card” disclosed an electronic playing card comprising electronic paper that displays a standard playing card consisting of one of a rank of Ace, 2, 3, 4, 5, 6, 7, 8, 9, 10, Jack, Queen, and King and one of a suit of Hearts, Diamonds, Clubs, and Spades. Two or more of such electronic playing cards can comprise an electronic playing card deck. The invention further provided an electronic playing card shuffler for electronically shuffling an electronic playing card deck by way of a wired or wireless signal, or alternatively, by way of an electronic paper printer adapted to shuffle the electronic playing card deck. The invention demonstrated an application of electronic paper display in game playing field. It is cited here as a reference. However, the electronic playing card according to the detailed description composes electronic paper display and an on-board operating unit, making it expensive to manufacture for regular use.

After intensive literature search including US patents, it is concluded that the state of art of educational flash cards or those closely related teaching apparatus that could be used as educational flash cards is that they are made of individual card or tile that has indicia permanently printed on its surface. Because of such feature, the disadvantages (1) to (6) listed previously are inherent. Therefore, in full consideration of the preceding review, it is desirable and practically possible to create a totally new type of educational flash card set that comprises of card whose displaying content is not permanently printed on its surface. With such a flash card, the display content is changeable, or erasable and writable, so that the flash card can display any content as needed. With such erasable and writable educational flash card, the disadvantages (1) to (6) can all be overcome. One additional benefit of such an erasable and writable educational flash card is that it will save large volume of conventional paper from being used to make conventional educational flash cards therefore conserve trees, plants and environment. The present invention provides an electrically erasable and writable educational flash card. The advantages of such card shall be revealed in the subsequent portions of this specification.

### BRIEF SUMMARY OF THE INVENTION

One object of the present invention is to provide an electrically erasable writable educational flash card. The display on the electrically erasable writable educational flash card can be changed to whatever is wanted whenever is needed by user through an electrical card writer. A plurality of the electrically erasable writable educational flash cards can form an educational flash card set of any learning subject the user chooses to learn at anytime. As such, user does not need to worry about the completeness of an educational flash card set due to card lost or damage because user can always write a card into what is needed. As such, user does not need to own a set of educational flash cards for each learning subject and multiple sets of the same educational flash cards for one learning subject in order to learn and play creatively. For example, only one electrically erasable writable educational flash card is needed to learn 26 English alphabets instead of at least 26 permanently printed conventional paper English alphabet flash cards. Only 15 electrically erasable writable educational flash cards are needed to spell out the sentence “mommy loves jimmy” instead of at least five sets of permanently printed conventional paper English alphabet flash cards—a total of at least 130 cards. More over, after erases and rewrites, user can change the font and style of these letters to any type or change the letters between upper case and lower case. More over, after erases and rewrites, user can use the very same 15 cards that are used to spell the sentence “mommy loves jimmy” to play scrambling/unscrambling word game with letters in the word “vegetable” being scrambled as “geeelatbv” (9 cards in total) and scrambling/unscrambling arithmetic game with numbers in the arithmetic equation 6×6=36 being scrambled as “X6636=” (6 cards in total). More over, after erases and rewrites the very same cards with X's and O's, user can play the fun game Tic-Tac-Toe. It should be understood that what listed here are just some examples of use of the present invention.

Another object of the present invention is to provide an educational flash card that the learner especially young children can write content on a flash card display themselves. Young children always like to participate. When a child is presented with an electrically erasable writable educational flash card of the present invention, the child pushes a button on one of the embodiment—the electrical card writer—and sees the content appearing and displaying on the card. If user chooses to, the display can be colorful, flashing, with sound or a combination of the above to strengthen the effect of visual strike to the children. Such participation brings enjoyment and excitation into the learning process, which in turn improves the learning effectiveness and efficiency. In contrast, when a conventional paper flash card is presented to a young child, it is static and the indicia on the card can only catch the child's attention with its bold color. Sometimes, children take the card itself as the learning subject instead of the indicia that is printed on the card.

Another object of the present invention is to provide an electrically erasable writable educational flash card that has certain mass, size and stiffness. Certain mass, size and stiffness makes the card feel like a toy and ergonomically fitful for young children to play and manipulate with. The beginning of learning age of young children is also the time period when they develop their fine motor skills Cards of certain mass, size and stiffness will require certain endeavor for young children to take and manipulate them around. To press a button or manipulate a stick on the electronic card writer will exercise the coordination between children's fingers and eyes. Such movement will be beneficial to children's fine motor skills development.

Another object of the present invention is to provide an electrically erasable writable educational flash card set that preferably needs two participants to use so that one is the teacher and the other is the learner with the teacher teaching and the learner learning through easy oral communications and body movements. Often the teacher is a parent and the learner is the child. In such case, the electrically erasable writable educational flash card set creates an environment that brings not only quality time between the parent and the young child but also training of communication skills to the young child at the same time. It is envisioned that children can play the electrically erasable writable educational flash cards as a learning toy, just like children play the conventional paper cards. It is also envisioned that multiple players use the electrically erasable writable educational flash cards to play scrambling and unscrambling word game or to play game of any learning subject to enjoy friendly competition with rules from any known games or with rules made by themselves as they go along.

Another object of the present invention is to provide an electrically erasable writable educational flash card set that will replace the conventional paper flash card set to save the use of conventional paper that consumes wood and forest and to conserve environment. One set of electrically erasable writable educational flash cards can be used as any set of subject learning conventional paper flash cards. Therefore, people can own it to learn any subject from very young preschool age to grade school age to adolescent age and even to adulthood.

Another object of the present invention is to provide an electrically erasable writable educational flash card set that is easily portable and can be played in small play area such as in an airplane seat during traveling time or in unfavorable outdoor environment such as in a beach where wind could blow away conventional paper flash cards.

In a first embodiment, the invention provides an electrically erasable writable educational flash card. Preferably, the flash card is of certain size, weight and stiffness such that it is ergonomically fitful for young children to use. At least one of the surfaces of the card comprises an electronic display, preferably a bistable electronic display. It should be understood that bistable display means text and images content that is displayed on the display when power is on can keep as it is and unchanged indefinitely when power is switched off. Bistable display does not need power staying on and does not consume power except when the display content is to be changed. One or more of the following technologies can be utilized to make such a display: Gyricon (registered trademark of Xerox Corporation), electrophoretic display, electronic ink film, electronic paper, electro-optic display, bistable nematic liquid crystal display (LCD), polymer dispersed materials, magnephoretic display, electrowetting e-paper, electrofluidic e-paper, or the like. It should be further understood that low power consumption display technology such as organic light emitting diode (OLED) technology, organic transistor based e-paper, etc., can also be used.

In a second embodiment, the invention provides an electrically erasable writable educational flash card set that comprises a plurality of electrically erasable writable educational flash cards. The total number of cards included in the set varies according to the learning subject, the applications environment, and the cost of card set. For example, a three-card set is adequate to learn all the 26 alphabetic letters of English and to play any three-letter word game. A six-card set is adequate to learn all the Arabic numeric numbers and play single digit addition, subtraction, multiplication and division including the symbols of plus, minus, multiplication, division and equality.

In a third embodiment, the invention provides an electronic writer comprising a transmitting means for transmitting information to an electrically erasable writable educational flash card, a visual display unit to display the operation of the writer and monitor the information to be transmitted to the electrically erasable writable educational flash card, an input device for the user to operate the writer, a central processing unit for executing application programs, user inputs and transmission of the information via the transmitting means to the electrically erasable writable educational flash card, and a storage that stores application software including those of the learning subjects. The transmitted information includes at least the visual display content or audial sounds or both. It is envisioned, however, that a commercially available desktop computer, or a notebook computer, or a cell phone, or a hand held device that has communication peripherals, or an electronic paper printer such as disclosed in the U.S. Pat. No. 7,114,864, entitled “Electronic paper printer” can also be used as an electronic writer to the electrically erasable writable educational flash card.

### BRIEF DESCRIPTION OF THE SEVERAL VIEWS OF THE DRAWING

Preferred embodiments of the present invention will now be described. The present invention will become apparent upon reference to these accompanying drawings.

FIG. 1A is a perspective view of the electrically erasable writable educational flash card according to the first embodiment of the present invention.

FIG. 1B is a block diagram illustration of the components used to construct the electrically erasable writable educational flash card of FIG. 1A.

FIG. 2 is a plurality of electrically erasable writable educational flash card of FIG. 1A forming a set of electrically erasable writable educational flash cards according to the second embodiment of the present invention.

FIG. 3 is a block diagram illustration of the electronic card writer according to the third embodiment of the present invention. The electronic card writer is used to erase and write display content on the electrically erasable writable educational flash card of FIG. 1A.

FIG. 4 illustrates a perspective view that illustrates an example of using 15 electrically erasable writable educational flash cards of FIG. 1A to spell a sentence “mommy loves jimmy.” Five m's are needed.

FIG. 5 is a perspective view that illustrates an example of using 6 electrically erasable writable educational flash cards of FIG. 1A to make an arithmetic equation 6×6=36.

FIG. 6 and FIG. 7 are perspective views that illustrate an example of using 9 electrically erasable writable educational flash cards of FIG. 1A to play a scrambling and unscrambling word game, for example, “vegetable.”

### DETAILED DESCRIPTION OF THE INVENTION

The electrically erasable writable educational flash card of the present invention is now described in detail with reference to the preferred embodiments diagrammed in the drawings.

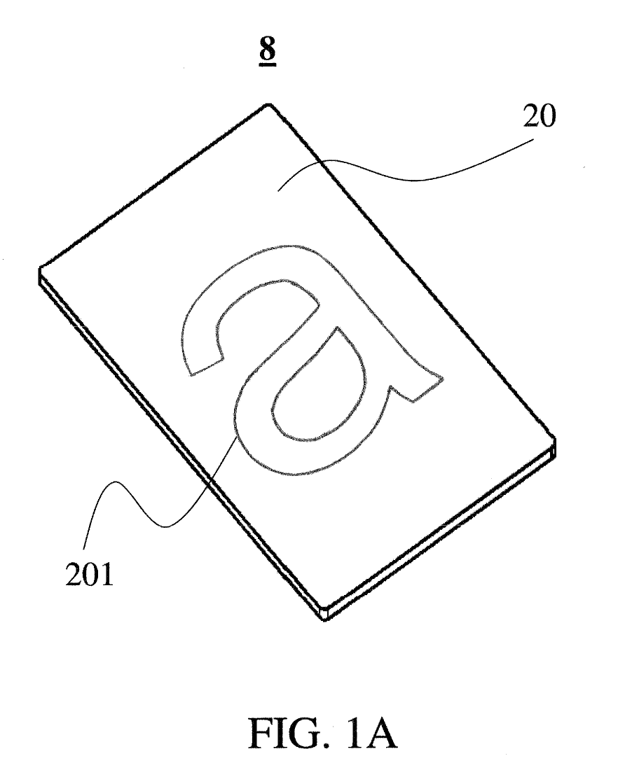

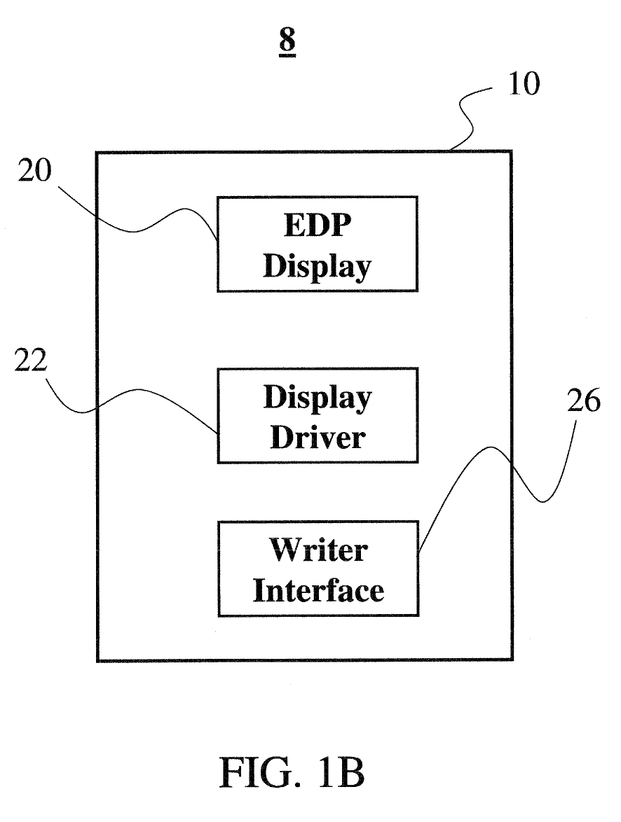

FIG. 1A is a perspective view of the electrically erasable writable educational flash card representing a first embodiment of the present invention. An electrically erasable writable educational flash card 8 indicated in FIG. 1A is a card with an electronic display panel 20 displaying content 201. The content 201 displayed on the surface of electronic display panel 20 can be erased and rewrote by an electronic card writer 6, which will be described subsequently, to display prescribed patterns such as text characters of a language, Arabic numbers, and graphics pictures. As an example in this illustration, the card displays a Times New Roman font lower case English text character “a.”

FIG. 1B is a block diagram illustration of the components of the electrically erasable writable educational flash card 8. An electrically erasable writable educational flash card 8 comprises a housing 10, an electronic display panel (EDP) 20, a display driver 22, and a writer interface 26.

The housing 10 houses the display 20, driver 22 and the writer interface 26. It provides protection of these components from damage. It also provides certain mass, size and stiffness to the flash card 8 such that it is ergonomically fitful for young children to use. It is desirable that the housing take a rectangular shape with ratio between the lengths of its short edge to its long edge in the range of 0.35 to 0.62. But is should be understood that other shape or ratio can also be used. The housing is made of conventional paperboard, plastic such as PVC or ABS, mold compound, aluminum, or stainless steel and combination thereof.

The EDP display 20 of the flash card 8 is a core component of the flash card 8 of the present invention. EDP 20 is made of electronic display by any of the following technologies: Gyricon (registered trademark of Xerox Corporation), electrophoretic display, electronic ink film, electro-optic display, bistable nematic liquid crystal display (LCD), polymer dispersed materials, magnephoretic display, electrowetting e-paper, electrofluidic e-paper, or the like. It should be further understood that low power display technologies such as organic light emitting diode (OLED) technology, organic transistor based e-paper, etc., can also be used. Preferably display 20 is a bistable electronic display so that the prescribed patterns such as text characters of a language, Arabic numbers, and graphics pictures can be written and displayed when power is on and kept displaying unchanged indefinitely after the power is switched off.

The display driver 22 of the flash card 8 converts information received from the writer interface 26 into an electric field and applies to the EDP 20 to properly display prescribed patterns. Typically, for an active matrix electronic display 20, the driver involves row and column driver parts.

The writer interface 26 of the electrically erasable writable educational flash card 8 is an interface to the electronic card writer 6 that will be described subsequently. It provides the transmission means between the flash card 8 and the electronic card writer 6. The transmission means can be a contact based or noncontact based. The contact based interface in general comprises USB, gold-plated contact pads, or D-subminiature connector while the noncontact based interface in general comprises radio frequency, Wi-Fi, or Bluetooth. It can further be a hybrid transmission means that use both contact and noncontact means for certain transmission tasks respectively.

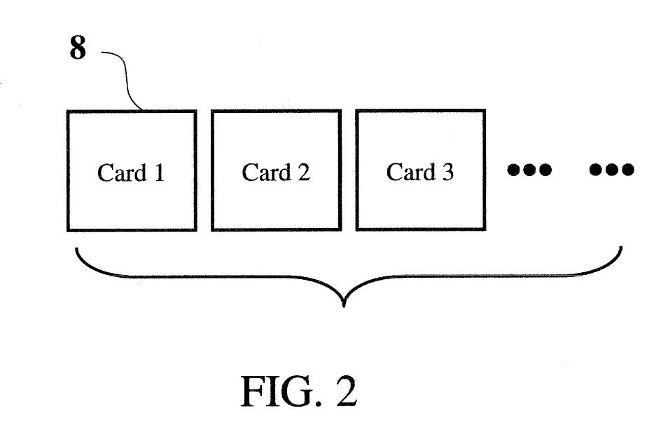

FIG. 2 is a block diagram illustration of an electrically erasable writable educational flash card set representing a second embodiment of the present invention. The set comprises a plurality of electrically erasable writable educational flash card 8 as described earlier in the first embodiment through FIG. 1A and FIG. 1B. The number of flash card 8 of a set depends on the specific learning subject. As discussed in the “Summary of Invention” section, the number can be just one for learning English alphabet or three for playing scrambling and unscrambling three-letter English word game. No preset limit of total number of flash card 8 is necessary for the set.

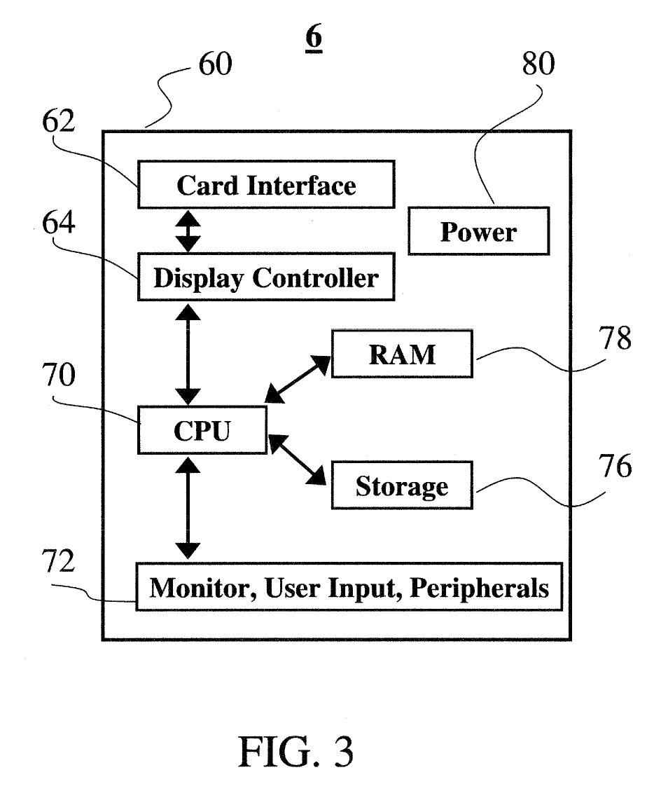

FIG. 3 is a block diagram illustration of an electronic card writer representing a third embodiment of the present invention. An electronic card writer 6 comprises a housing 60, a card interface 62, a display controller 64, a central process unit (CPU) microprocessor 70, random access memory (RAM) 78, storage 76, peripherals 72 such as monitor, speaker and user input devices, and power supply unit 80.

The housing 60 is made of plastic such as PVC or ABS, aluminum, stainless steel, or the like and combination thereof. It provides house and support to the card interface, the display controller, the CPU, the RAM, the storage, the peripherals and the power supply unit.

The electronic card writer 6 comprises a card interface 62. The card interface 62 works with the writer interface 26 of the electrically erasable writable educational flash card 8 to form the transmission means between the flash card 8 and the card writer 6. In according to the writer interface 26 described earlier, the card interface 62 can be contact based such as USB, gold-plated contact pads, D-subminiature connector, or noncontact based such as radio-frequency, Wi-Fi, or Bluetooth. It can further be a hybrid transmission means that use both contact and noncontact means for certain transmission tasks.

The electronic card writer 6 further comprises a display controller 64. The display controller is an integrated circuit module for processing the information to be transmitted through the card interface 62 to the flash card 8. It also controls the information displayed on the visual display unit or the monitor of peripherals 72, which will be described subsequently, of the electronic card writer 6.

The electronic card writer 6 further comprises a central processing unit (CPU) microprocessor 70. The CPU loads and executes programs and instructions, operates on user application data, much like what a CPU does in the desktop computer or laptop computer.

The electronic card writer 6 further comprises a random access memory (RAM) 78. The RAM unit works with the CPU 70 of the electronic card writer 6. It can be dynamic RAM (DRAM) or static RAM (SRAM).

The electronic card writer 6 further comprises storage 76. The storage 76 is used to store basic input/output system (BIOS), operating system software, application software of the educational learning subjects, and application related data. It can be any type of static random access memory (SDRM) and non-volatile flash memory. It can also be a unit to take external storage such as flash memory card, USB storage, hard drive storage, floppy disk, or the like.

The electronic card writer 6 further comprises peripherals 72. It should be understood that by peripherals it means input/output accessory devices that include at least some of the following: the visual display unit or monitor, user input devices such as standard keyboard, standard mouse, pointing stick and buttons, touch pad and buttons, touch screens, hand writing pad, audial speaker, camera and combination thereof.

The electronic card writer 6 further optionally comprises a power supply unit 80. The power supply unit 80 provides the power that is needed to operate the electronic card writer 6. The electronic card writer 6 provides two power supply options. It can receive power through an external power supply or a built-in power source such as batteries.

It should be understood that some of the components 62, 64, 70, 72, and 76 of the electronic card writer 6 could be combined into a single component. For example, a less functional CPU 70, storage 76 and small amount of RAM 78 can appear in the form of a microcontroller unit (MCU) component or a digital signal processor (DSP), which is a specialized microprocessor with optimized architecture for fast operational needs at a lower cost.

It should be understood that the electronic card writer 6 could be embodied merely as an electronic accessory device. Such a simplified device can be just an interface device connecting the flash card 8 to a readily available commercial computer or a handheld smart cellular phone with most of the functions of the electronic card writer 6 being carried out by the computer or the cellular phone.

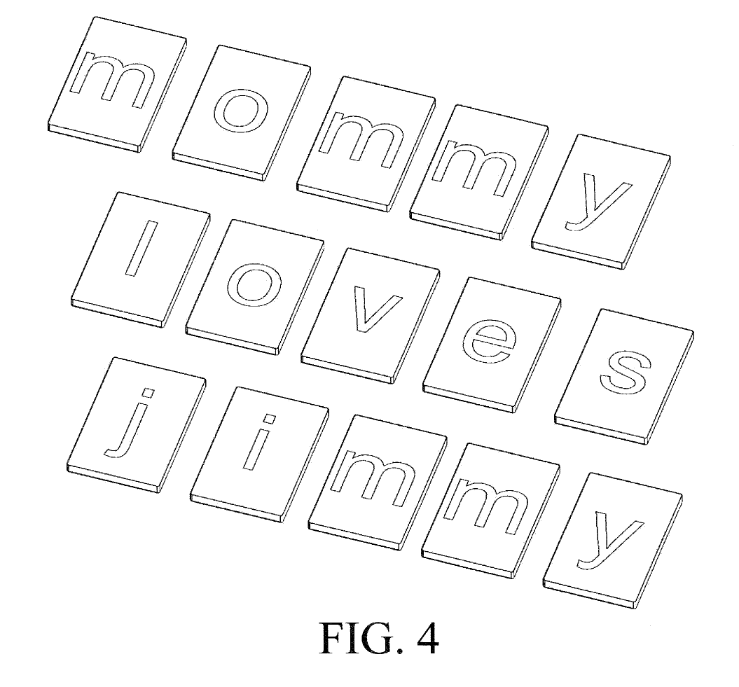

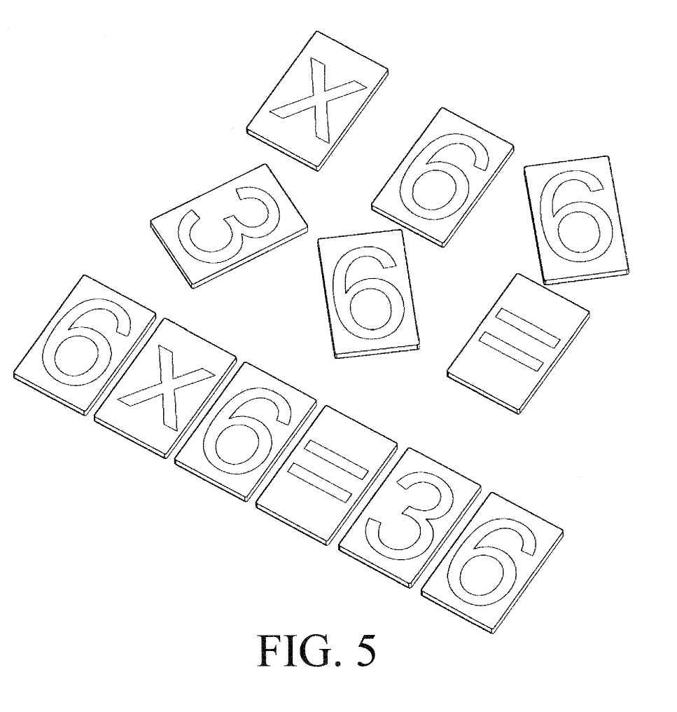

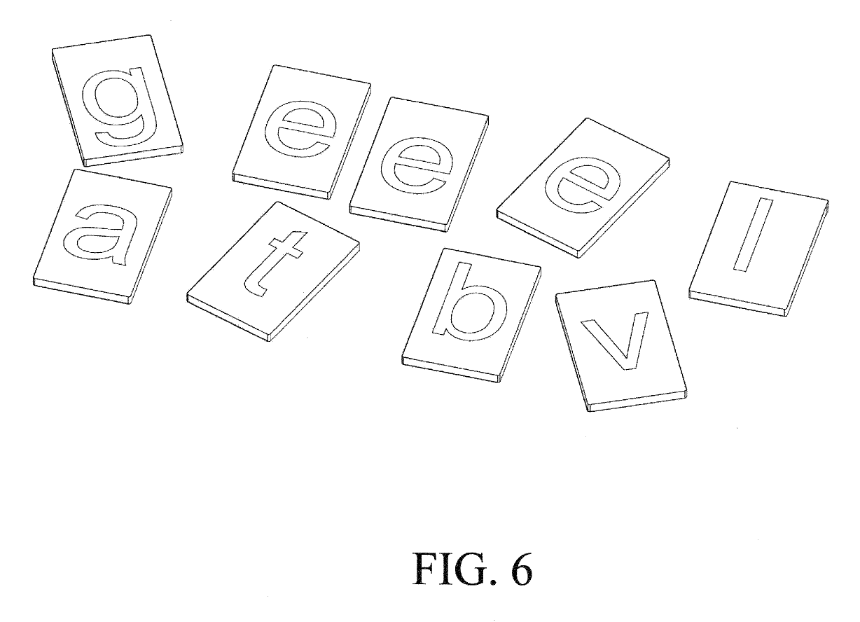

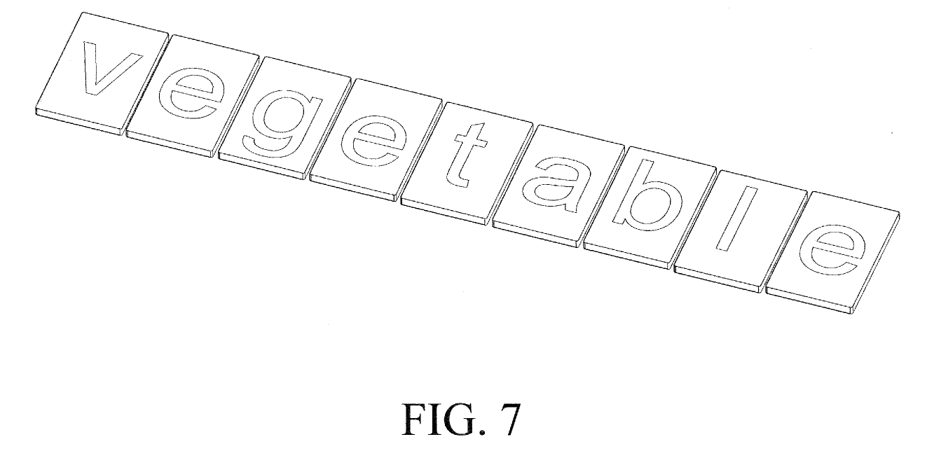

FIG. 4-7 illustrates examples of the advantages of the electrically erasable writable educational flash card set. Assume a set comprises 15 electrically erasable writable educational flash cards 8. FIG. 4 illustrates an example of the advantages of the electrically erasable writable educational flash card. User can spell out a sentence “mommy loves jimmy.” It takes little effort and time to spell out the letters and the sentence with the electronic card writer 6. In contrast, if conventional paper based English alphabet flash cards are used, user needs to have five sets of them in order to have five m-cards. In addition, user needs pick five m-cards out of a total of 130 cards, which takes time and efforts. Another advantage is that children can participate making these 15 flash cards by choosing and pressing buttons on the electronic card writer 6 for added fun. Children can also play with these cards and move them around on the carpet, table or floor to spell out any meaningful sentence. FIG. 5 illustrates another example of the advantages of the electrically erasable writable educational flash card. Using 6 out of the 15 electrically erasable writable educational flash cards 8 that have been used in FIG. 4, user can easily change learning subject to arithmetic by making an arithmetic equation such as 6×6=36. At the same time, FIG. 6 and FIG. 7 illustrate another example of the advantages of the electrically erasable writable educational flash card. Using the rest 9 out of the set of 15 electrically erasable writable educational flash cards 8, user can play scrambling/unscrambling English word game such as a 9-letter word “vegetable” or any word comprises fewer letters. It is readily understood from these examples that the electrically erasable writable educational flash card can be used to learn any subject.

The present invention has mainly been described above with reference to certain explicitly disclosed preferred embodiments thereof. However, as is readily appreciated by any person skilled in the art, other embodiments than these ones disclosed above are equally possible within the scope of the invention, as defined by the appended patent claims. It should be understood that all terms used in the claims are to be interpreted according to their ordinary meaning in the technical field, unless explicitly defined otherwise herein.

What is claimed is:

1. An electrically erasable writable educational flash card, comprising:
an electronic display panel for displaying prescribed patterns such as text characters of a language, Arabic numbers, and graphics pictures of a learning subject;
a display driver, operably connected to said electronic display panel for erasing and writing said prescribed patterns on said electronic display panel;
an interface operably connected to said display driver and to an external information transmission source; and
a housing of certain mass, size and stiffness made of a material selected from a group comprising conventional paper, plastic, aluminum, stainless steel, or the like and combination thereof, whereon said electronic display panel, said display driver and said interface are arranged and housed.

2. An electrically erasable writable educational flash card according to claim 1, wherein patterns displayed on said electronic display panel is erasable and writable by user.

3. An electrically erasable writable educational flash card according to claim 1, wherein said electronic display panel is bistable display.

4. An electrically erasable writable educational flash card according to claim 1, wherein said electronic display panel is electronic paper display.

5. An electrically erasable writable educational flash card according to claim 1, wherein said electronic display panel is electronic paper display based on electronic ink film technology.

6. An electrically erasable writable educational flash card according to claim 1, wherein said electronic display panel is bistable nematic liquid crystal display.

7. An electrically erasable writable educational flash card according to claim 1, wherein said display driver erases and changes electronically the display patterns on said electronic display panel.

8. An electrically erasable writable educational flash card according to claim 1, wherein said interface is connected to an external information transmission source through a contact means.

9. An electrically erasable writable educational flash card according to claim 1, wherein said interface is connected to an external information transmission source through a noncontact means.

10. An electrically erasable writable educational flash card according to claim 1, wherein said housing takes certain size, weight and stiffness that is ergonomically fitful for young children to play.

11. An electrically erasable writable educational flash card set, comprising:
a plurality of electrically erasable writable educational flash cards.

12. An electronic card writer, comprising:
a card interface for transmitting information to the electrically erasable writable educational flash card;
a display controller for processing information to be transmitted to the electrically erasable writable educational flash card and for controlling the information to be displayed on the visual display unit of said electronic card writer;
a central process unit (CPU) microprocessor for executing application programs and user instructions and controlling peripheral devices;
random accessible memory (RAM) for said CPU operation;
storage for storing basic input/output system, operating systems and application software of learning subjects;
visual display unit for displaying input, output and operation status information;
speaker for sound output;
input devices for user to operate said electronic card writer by inputting commands and instructions;
a power supply unit for providing electric power to said electronic card writer; and
a housing for supporting and housing said card interface, said display controller, said CPU, said RAM, said storage, said visual display unit, said speaker, said input devices and said power supply unit.

13. An electronic card writer of claim 12, wherein said CPU is a digital signal processor (DSP).

14. An electronic card writer of claim 12, wherein said CPU is a microcontroller unit (MCU).

15. An electronic card writer of claim 12, wherein said power supply unit is a group of batteries or an external power supply source.
